(19) United States
(12) Patent Application Publication
(10) Pub. No.: US 2011/0113344 A1
(43) Pub. Date: May 12, 2011

(54) METHOD AND SYSTEM OF DESKTOP BROADCASTING

(75) Inventor: Chao-Hsuan Hsueh, Taipei (TW)

(73) Assignee: ATEN INTERNATIONAL CO., LTD., Taipei (TW)

(21) Appl. No.: 12/917,398

(22) Filed: Nov. 1, 2010

(30) Foreign Application Priority Data
Nov. 10, 2009 (TW) 098138172

(51) Int. Cl. G06F 3/01; G06F 15/16

(52) U.S. Cl. 715/740

(57) ABSTRACT

A method for desktop broadcasting is provided. The method includes providing a server and plural client ends; assigning one of the plural client ends as a repeater; connecting the repeater to the server by utilizing a remote desktop control service; connecting the repeater to other client ends of the plural client ends; and sending a command from the server to the other client ends via the repeater.

### FIELD OF THE INVENTION

The present invention relates to a desktop broadcasting method and system, and particularly to a desktop broadcasting method and system by utilizing a remote desktop control service.

### BACKGROUND OF THE INVENTION

In conventional remote desktop control services, a communication protocol known as the remote desktop protocol (RDP) has been developed by Microsoft®, which allows a user to remotely control and operate through a graphic interface after the user remotely logs in from, for example, a client end which may be a desktop computer of the user. The RDP actually has been built in the Windows® operation system by Microsoft® or in another program, Hyper V Server, developed by Microsoft®.

When the RDP is adopted, the loading of the central processing unit (CPU) of the computer becomes lower, because there is no need for the operation system of the computer to perform the actual actions of the graphic drawing, but a graphic command (or plot command) is sent to the client end through the Ethernet instead. That is, the graphic drawing is processed at the client end. Therefore, the RDP has the advantages of smaller transmitted packets, lower required bandwidth, lower computer operations and higher frame rate for the displayed picture at the client end. In addition, the update technique of the RDP 7.0 version can further significantly eliminate the drawbacks of slow video display and non-synchronicity between the video and audio data when the video and audio information is transmitted.

However, the communication protocol of the RDP cannot be used for broadcasting. The command packets can only be transmitted from one client end to another client end, and cannot be transmitted to several logged-in clients (or users). This condition results from the setting of the Windows® operation system (OS), which allows only one user to log in. Although the Server version of Windows® OS allows plural users to log in at the same time and to use the RDP via the internet, each user still cannot share the same operation interface. Moreover, even if each user uses the same account to log in, the users still cannot see the same operation interface. As a result, there is certainly no broadcasting can be done.

On the other hand, if a virtual network computing (VNC) technique or the keyboard-video-mouse over IP (iKVM) technique via the internet communication protocol is adopted, the effect of desktop broadcasting may be achieved, but the performances of the loading of the computer operation and the frame rate of the displayed picture on the computer are inferior to those by adopting the RDP. Moreover, when the VNC or iKVM technique is adopted, complicated steps are required which are very inconvenient for the users. For example, in order to log into the server, each user must completely key in the server IP address, account identification and password so as to be connected into the shared network. In additions, the VNC and iKVM directly transmit the whole picture information rather than the small packets of the graphic commands for the graphic drawing by each client end, which results in poor broadcasting effect. Furthermore, when more users log into the connection via the VNC technique or the iKVM technique, the loading of the server becomes significantly heavier.

### SUMMARY OF THE INVENTION

The present invention provides a desktop broadcasting method and system to overcome the above discussed drawbacks of the conventional techniques.

In accordance with one aspect of the present invention, a method for desktop broadcasting is provided. The method comprises providing a server and plural client ends; assigning one of the plural client ends as a repeater; connecting the repeater to the server by utilizing a remote desktop control service; connecting the repeater with other client ends of the plural client ends; and sending a command from the server to the other client ends via the repeater.

In accordance with another aspect of the present invention, a desktop broadcasting system is provided. The system comprises a server and plural client ends, one of which is assigned as a repeater connecting with the sever and other client ends of the plural client ends, wherein the sever sends a command to the other client ends via the repeater.

In accordance with a further aspect of the present invention, a desktop broadcasting system is provided. The system comprises a server and plural client ends divided into plural groups, each of the groups has a respective repeater connecting with the server and at least one other client end in the same group by utilizing a remote desktop control service, wherein the respective repeater has a desktop information to be sent to the at least one other client end.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing the configuration of the desktop broadcasting system of one exemplary embodiment of the present invention;

FIG. 2 is the schematic diagram showing the configuration of the desktop broadcasting system of another exemplary embodiment of the present invention; and

FIG. 3 is the schematic diagram showing the flowchart of one exemplary embodiment of the desktop broadcasting method of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

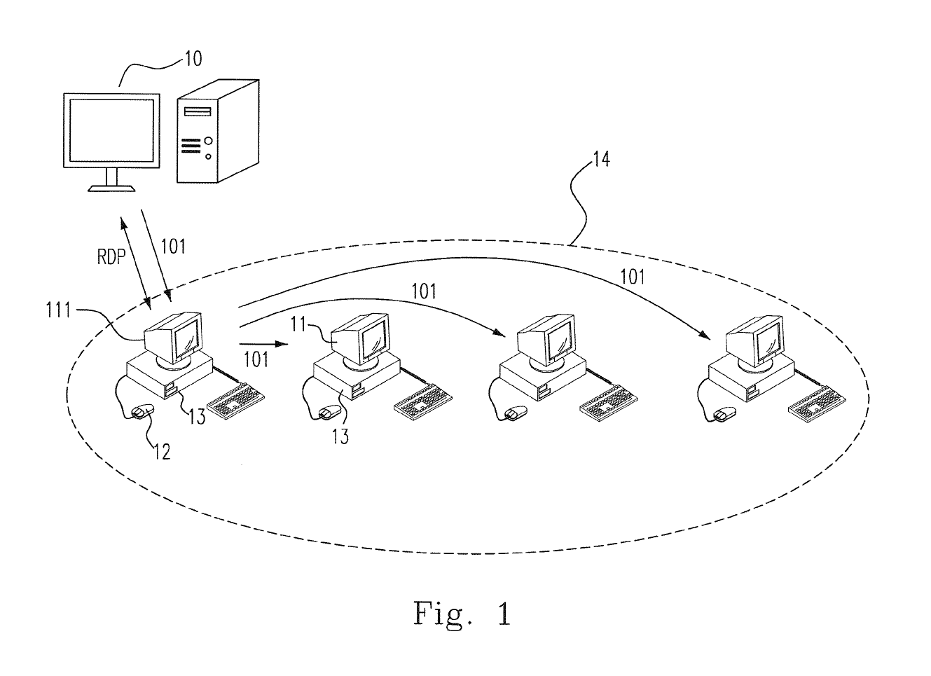

Referring to FIG. 1, there is shown the configuration of the desktop broadcasting system of one exemplary embodiment in the present invention. This system includes a server 10 which makes connection and communication with one of plural client ends 11 by utilizing a remote desktop control service, e.g. remote desktop protocol, RDP. Each client end 11 includes at least one input device 12 and one graphic processor 13. One of the client ends 11, such as client end 111 connected with server 10, may be assigned as and therefore becomes a repeater. The repeater 111 sends conference invitations to and makes connections with the other client ends 11. After making all connections, if a user at the repeater 111 uses the input device 12 to control and operate to perform an action, e.g. drawing a graph or picture, then the operation action will proceed at server 10. However, there is no need for sever 10 to actually perform the function to draw graphs. Instead, server 10 generates a graphic command 101 accordingly, and sends the graphic command 101 back to repeater 111. The graphic processor 13 of repeater 111 in turn makes the drawing action.

After the server 10 transmits the graphic command 101 to repeater 111, the repeater 111 can also forward graphic command 101 to the other client ends 11, since repeater 111 has already made conference connections with the other client ends 11. After each such other client end 11 receives the graphic command 101, the respective graphic processor 13 of each client end 11 makes the same drawing action. In this way, when the user at repeater 111 performs certain drawing action, the same picture can be presented in each client end, therefore achieving the purpose of desktop broadcasting.

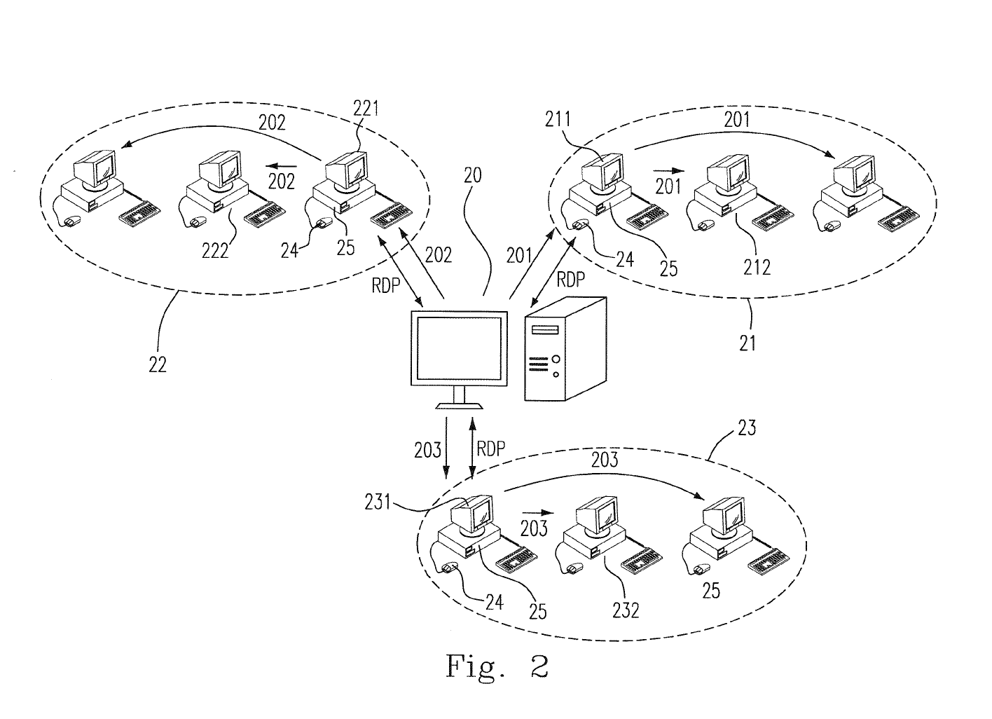

Referring to FIG. 2, there is shown a schematic diagram of the configuration of the desktop broadcasting system of another exemplary embodiment of the present invention. This system includes a server 20 which makes a connection and communication with one of plural client ends 212 in the first group 21 by utilizing a remote desktop control service, e.g. remote desktop protocol, RDP. Each client end 212 includes at least one input device 24 and one graphic processor 25. The client end 212 connected with the server 20 may be assigned as and therefore becomes a repeater 211, which can send conference invitations to and make connections with the other client ends 212. After the connections are completely made, when a user at the repeater 211 uses the input device 24 to perform certain operation actions, e.g., drawing a graph or picture, server 20 generates a graphic command 201 accordingly, and sends the graphic command 201 to repeater 211. Then the graphic processor 25 of repeater 211 performs the drawing actions. In addition, the repeater 211 forwards the graphic command 201 to the other client ends 212. After each client end 212 receives the graphic command 201, the respective graphic processor 25 of each client end 212 performs the same drawing actions. In this way, all the users in the first group 21 can see the same picture, and accordingly the purpose of the desktop broadcasting can be achieved.

At the same time, server 20 can also make connections and communications with one of plural client ends 222 in the second group 22 and one of plural ends 232 in the third group 23, where each of the client ends 222 and 232 includes a respective input device 24 and a respective graphic processor 25. The client ends 222 and 232 connected with server 20 become the repeaters 221 and 231 for their respective groups, which then send the conference invitations to and make connections with the other client ends 222 and 232 in their groups, respectively. After all the connections have been made, when the users at the repeaters 221 and 231 perform certain actions, respectively, by using the input devices 24, server 20 will generate graphic commands 202 and 203, and send the graphic commands 202 and 203 to the corresponding repeaters 221 and 231, respectively. Then the respective graphic processors 25 of repeaters 221 and 231 perform the drawing actions, respectively. Moreover, the repeaters 221 and 231 can forward the graphic commands 202 and 203 to the corresponding other client ends 222 and 232, respectively. After each of the client ends 222 and each of the client ends 232 receive the corresponding graphic commands 202 and 203, respectively, the respective graphic processors 25 of the client ends 222 and 232 make the drawing actions. In this way, all the users in groups 21, 22 and 23 can see the same respective pictures as that at the corresponding repeaters 211, 221 and 231. Accordingly, the purpose of the desktop broadcasting can be achieved.

Certainly, each of groups 21, 22 and 23 can be located in one independent local area network (LAN), or two of groups 21, 22 and 23 can be located in the same LAN, or all groups can be located in the same LAN without any particular limitation. In this embodiment, the “network” includes but is not limited to internet, intranet, Ethernet, LAN, wide area network (WAN) and wireless network.

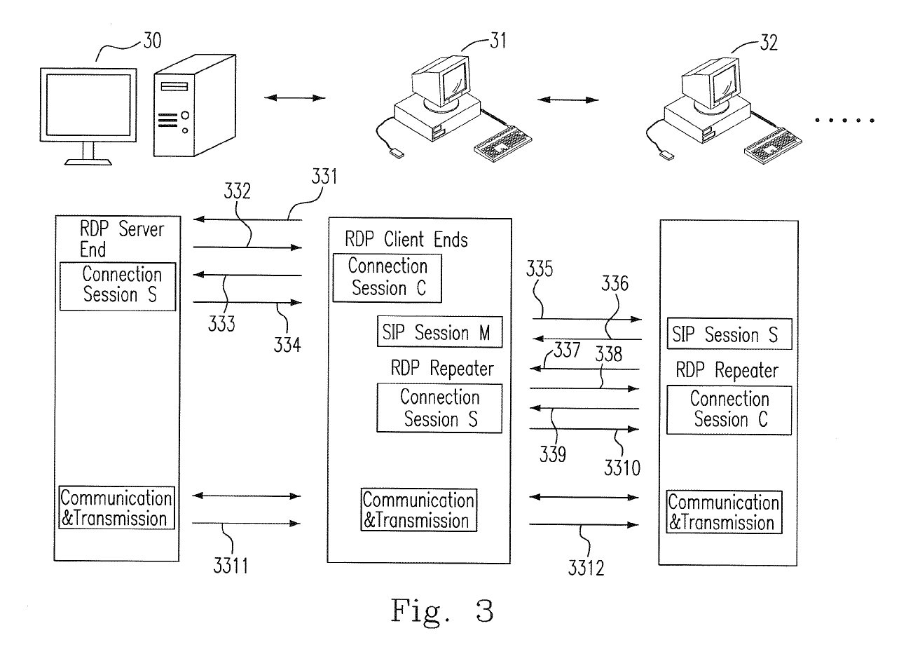

The procedures of the above mentioned arrangement of the connections and communications can be illustrated by FIG. 3, which is the schematic diagram showing the flowchart of one exemplary embodiment of the desktop broadcasting method of the present invention. It is noted that since the desktop broadcasting methods in the present invention utilize a remote desktop control service, e.g. remote desktop protocol (RDP), the connection between the repeater 31 and the server 30 is made by utilizing the protocol of the remote desktop control service. The client end that communicates with server 30 is assigned as repeater 31. Initially the connection between repeater 31 and server 30 is made. There are usually four steps in this stage. In this stage, server 30 performs the role of a server end during the connection session, and can be abbreviated as Connection Session S. The repeater 31 performs the role of a client during the connection session, and can be abbreviated as Connection Session C. In step 331, repeater 31 sends a connection request to server 30 first. In step 332, server 30 responds to the request and sends a public key in order to establish a certification mechanism between server 30 and repeater 31 and to verify and to confirm the identity of the client end. In step 333, after receiving the public key, the repeater 31 sends the encrypted account number (or user name) and password back to server 30 for verification. In step 334, after confirming that the client end is an authorized client through verification, server 30 responds a message of accepting the connection request. In such a process the connection between repeater 31 and server 30 is established. Of course the connection between server 30 and repeater 31 by the remote desktop control service can be requested by repeater 31 or invited by server 30 without any limitation in this embodiment.

After establishing the connection with server 30, repeater 31 then makes connections with the other client end(s) 32. In one embodiment, the conference connection may be made by utilizing Session Initiation Protocol (SIP), for example. Of course other connection protocols and conference invitation ways can be utilized as well without any limitation. As shown in FIG. 3, the role of repeater 31 during the session is a Master, and can be abbreviated as SIP Session M; while the role of client end(s) 32 during the session is a Slave, and can be abbreviated as SIP Session S. In step 335, repeater 31 sends the conference invitation request to client end(s) 32. In step 336, client end(s) 32 responds a message of accepting the conference invitation. Accordingly, the conference connection between repeater 31 and respective client end(s) 32 is established.

For further confirming the identification and the encrypted data, the confirmation step can proceed by utilizing the remote desktop control service, after repeater 31 has connected with the other client end(s) 32. In this stage, the role of the repeater 31 during the connection session is a server end, and can be abbreviated as Connection Session S; while the role of the client end(s) 32 during the connection session is a client end, and can be abbreviated as Connection Session C. In step 337, client end(s) 32 sends a request for making a connection to repeater 31. In step 338, repeater 31 responds the request and send a public key in order to establish a certification mechanism between repeater 31 and client end(s) 32 and to verify and to confirm the identity of the client end. In step 339, after receiving the public key, client end(s) 32 sends the encrypted account number (or user name) and password back to repeater 31 for verification. In 3310, after confirming that the client end(s) 32 is an authorized client through the verification process, repeater 31 responds a message of accepting the connection request. In such way, the certification and verification mechanisms between client end(s) 32 and repeater 31 have been established. Alternatively the steps 337 to 3310 may be omitted, or processed by adopting other protocols.

After the above mentioned connection steps are completed, the broadcasting actions can start. When a user at the repeater 31 performs certain operation actions, e.g. drawing a graph or picture, the command of the operation actions is in fact transmitted via the network to server 30 for processing the operation actions by using a wired or wireless communication method. In step 3311, server 30 transmits a graphic command based on the operation actions back to repeater 31 so that repeater 31 performs the drawing action according to the graphic command and then displays the graph or picture, i.e. the result of the drawing action. In step 3312, repeater 31 simultaneously sends that graphic command to the other client end(s) 32. The respective client end(s) 32 then makes the drawing according to the graphic command and then displays the same graph or picture. Accordingly, the synchronous desktop broadcasting is achieved.

In this embodiment, the repeater sends the graphic command to the respective client end(s) preferably by utilizing the protocol of the remote desktop control service. Since the connection between the repeater and the server is made by utilizing the remote desktop control service, the remote desktop control service will be utilized accordingly when the server sends the graphic command to the repeater. However, if the repeater adopts other protocol to send the graphic command to the respective client end(s), the resource is wasted and the error or damage during the data transformation may occur. Therefore, the remote desktop control service may be divided into two stages, i.e. connection stage and function stage. After the repeater connects with the respective client end(s) by utilizing the protocol of SIP, the connection stage of the remote desktop control service is done, and the function stage of the remote desktop control service begins which sends the graphic command. In additions, beside the Remote Desktop Protocol (RDP) from Microsoft® adopted in the present invention as the remote desktop control service, other the remote desktop control services, e.g. Independent Computing Architecture (ICA) technique from Citrix, can be used as well without any limitation.

When inviting the client end(s) to join the conference, the repeater can recognize the client ends to be invited through looking at the IP addresses of the client ends, the addresses of Media Access Control (MAC) of the client ends or the user names of the client ends. Furthermore, the displayed image at the repeater may include a Graphic User Interface (GUI), which can contain the addresses of client ends to be invited, user names, etc. for providing the direct control to the users so that the convenient management of the conference members can be achieved through various inputs, deletions, invitations and status displays in the columns. Of course the above contents in GUI are described as examples without any limitation for the present invention.

The client ends in the present invention can be desktop computers, laptop computers, palmtop computers, personal digital assistants (PDAs), cellular phones, notebook computers or other mini- or compact computers such as the thin client computers, or other data processing apparatus. Since the required functions of the client ends only include connection sessions, communications, transmissions and graphic drawing, other redundant software or hardware are unnecessary, and accordingly the costs at wide applications can be largely reduced. The repeater selected from the client ends can have the capability of arbitration. That is to say, the operation actions at the repeater can be replaced by those at the assigned one of the broadcasted client ends instead. Basically, during the broadcasting, each client end passively receives the graphs or pictures, and the displayed pictures therein are controlled and operated by the user at the repeater, that is, the client ends themselves do not have the authority to control. In the present invention, the role of the repeater not only forwards the graphic command to all the client ends connected in the conference, but also has the authority to assign anyone to take over the control. Thus, increased flexibility and convenience for the usages can be attained.

The system and method of the desktop broadcasting in the present invention can effectively solve the problem in conventional techniques where plural users cannot simultaneously obtain the same pictures when using RDP protocol in the conventional techniques. Moreover, comparing with the conventional broadcasting techniques, the present invention needs only one user, i.e. the repeater, to manage all the connections. Meanwhile, in the present invention, the requirements for software and hardware are lower, while the quality of the broadcasting can be ensured, and higher beneficial effects can be achieved with lower costs.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for desktop broadcasting, comprising:
providing a server and plural client ends;
assigning one of the plural client ends as a repeater;
connecting the repeater to the server by utilizing a remote desktop control service;
connecting the repeater to other client ends of the plural client ends; and
sending a command from the server to the other client ends via the repeater.

2. A method of claim 1, further comprising steps of:
causing the repeater to function as a virtual server for connecting with the other client ends; and
after receiving the command from the server, performing actions by the repeater and the other client ends according to the command.

3. A method of claim 1, wherein the command is a graphic command, and each of the repeater and the other client ends draws a graph according to the graphic command.

4. A method of claim 1, further comprising a step of:
causing the repeater to determine whether the other client ends are authorized to operate the command.

5. A method of claim 1, wherein:
the repeater actively connects with the other client ends;
the repeater is replaceable by one of the other client ends; and
the server, the repeater and the other client ends transmit and receive the command through the remote desktop control service.

6. A method of claim 1, wherein the plural client ends are divided into plural groups, each of which has a corresponding repeater making a connection with at least one client end in the same group.

7. A method of claim 1, further comprising a step of performing a certification process for connections between the repeater and the other client ends.

8. A desktop broadcasting system, comprising:
a server; and
plural client ends, one of which is assigned as a repeater making connections with the sever and other client ends of the plural client ends,
wherein the sever sends a command to the other client ends via the repeater.

9. A desktop broadcasting system of claim 8, wherein:
the repeater functions as a virtual server for connecting with the other client ends;
the command is a graphic command; and
each of the repeater and the other client ends has a graphic processor drawing a graph according to the graphic command after receiving the graphic command.

10. A desktop broadcasting system of claim 8, wherein:
each of the plural client ends has an input device;
the repeater controls the input devices to perform an operation;
the repeater actively notifies the other client ends to make the connections;
if the repeater malfunctions, then any other client end can assume its repeater function; and
the repeater and the other client ends are thin client computers, and are located in a local area network.

11. A desktop broadcasting system of claim 8, wherein the plural client ends are divided into plural groups, each of which has a corresponding repeater making a connection with at least one client end in the same group.

12. A desktop broadcasting system of claim 8, wherein the server, the repeater and the other client ends transmit and receive the command by utilizing a remote desktop control service.

13. A desktop broadcasting system of claim 12, wherein the remote desktop control service includes a technique being one of a remote desktop protocol and an independent computing architecture.

14. A desktop broadcasting system, comprising:
a server; and
plural client ends divided into plural groups, each of which has a respective repeater connecting with the server and at least one client end in the same group by utilizing a remote desktop control service,
wherein the respective repeater has a desktop information to be sent to the at least one corresponding client end.

15. A desktop broadcasting system of claim 14, wherein:
the respective repeater functions as a virtual server for connections with the at least one client end.

16. A desktop broadcasting system of claim 14, wherein:
the server sends a respective graphic command, based on an action of the respective repeater, to the at least one client end through the respective repeater; and
each of the respective repeater and the respective at least one client end in the same group has a graphic processor drawing a graph according to the respective graphic command after receiving the respective graphic command.

17. A desktop broadcasting system of claim 14, wherein the server, the repeaters and the corresponding client ends transmit and receive the respective graphic commands through a remote desktop control service.

18. A desktop broadcasting system of claim 17, wherein the remote desktop control service includes a technique being one of a remote desktop protocol and an independent computing architecture.

19. A desktop broadcasting system of claim 14, wherein each of the plural client ends has an input device, and the respective repeater assigns at least one client end to operate the input device thereof.

20. A desktop broadcasting system of claim 14, wherein:
the respective repeater actively notifies the respective at least one client end to make the connections;
if a respective repeater malfunctions, then any other client end in the same group can assume its repeater function;
the plural client ends are thin client computers; and
the respective repeater and the respective at least one client end in the same group are located in a local area network.
